(19) United States
(12) Patent Application Publication
(10) Pub. No.: US 2010/0140154 A1
(43) Pub. Date: Jun. 10, 2010

(54) GROUP IV METAL OXIDE MONOLITHIC COLUMNS

(75) Inventors: Luis A. Colon, Amherst, NY (US); David C. Hoth, East Aurora, NY (US)

Correspondence Address: NIXON PEABODY LLP - PATENT GROUP, 1100 CLINTON SQUARE, ROCHESTER, NY, 14604, US

(73) Assignee: The Research Foundation of State University of New York, Amherst, NY (US)

(21) Appl. No.: 12/280,069

(22) PCT Filed: Mar. 9, 2005
(86) PCT No.: PCT/US05/07687

§ 371 Date: Oct. 22, 2008

Related U.S. Application Data
(60) Provisional application No. 60/551,471, filed on Mar. 9, 2004.

(51) Int. Cl. B01D 15/22; C08J 9/00

(52) U.S. Cl. 210/198.2; 521/92; 521/93

(57) ABSTRACT

The present invention discloses methods of preparing a continuous, porous metal oxide monolith in a container. The method involves providing a reaction mixture containing a metal salt or metal alkoxide compound, a solvent, and a porogenic reagent. Next, an epoxide is added to the reaction mixture under conditions effective to initiate condensation and polymerization of the reaction mixture. Then, a container is filled with the reaction mixture after epoxide addition to obtain a continuous, porous metal oxide monolith in the container. The present invention also discloses columns including a tubular container and a continuous, porous Group IV metal oxide monolith in contact with the inner walls of the tubular container, where the Group IV metal oxide monolith is free of any support or matrix material, and other articles including a continuous, porous Group IV metal oxide monolith, where the metal oxide monolith is free of any support or matrix material.

This application claims the benefit of U.S. Provisional Patent Application Ser. No. 60/551,471, filed Mar. 9, 2004, which is hereby incorporated by reference in its entirety.

This invention arose out of research sponsored by the National Science Foundation (Grant No. CHE-0138114). The U.S. Government may have certain rights in this invention.

### FIELD OF THE INVENTION

The present invention relates to methods of preparing a continuous, porous metal oxide monolith in a container, as well as columns, porous filters, porous disks, and porous rods containing a continuous, porous metal oxide monolith prepared by such methods. The present invention also relates to columns and other articles containing a continuous, porous Group IV metal oxide monolith, where the Group IV metal oxide in the monolith is free of any support or matrix material.

### BACKGROUND OF THE INVENTION

A monolithic column consists of an interconnected skeletal structure inside of a tube (or channel), that forms a continuous bed of chromatographic material with flow through paths. This concept of a chromatographic column has been identified as an alternative to particle-packed columns for more than a decade (Svec et al., “Continuous Rods of Macroporous Polymers as High-Performance Liquid Chromatography Separation Media,” Analytical Chemistry, 64:820-822 (1992); Hjerten et al. “High-Performance Liquid Chromatography on Continuous Polymer Beds,” Journal of Chromatography, 473:273-275 (1989); Cortes et al., “Porous Ceramic Bed Supports for Fused Silica Packed Capillary Columns Used in Liquid Chromatography,” Journal of High Resolution Chromatography and Chromatography Communications, 10:446-448 (1987)), and offers several advantages over the other column formats (Tanaka et al., “Monolithic LC Columns.” Analytical Chemistry, 73:420A-429A (2001); Eeltink et al., “Comparison of the Efficiency of Microparticulate and Monolithic Capillary Columns,” Journal of Separation Science, 27:1431-1440 (2004); Minakuchi et al., “Octadecylsilated Porous Silica Rods as Separation Media for Reversed-Phase Liquid Chromatography,” Analytical Chemistry, 68:3498-3501 (1996)). The chromatographic monolithic structures are very attractive for high-performance liquid chromatography (HPLC) as they considerably reduce the pressure requirements to drive the mobile phase through the column, allowing the use of higher than usual mobile phase linear velocities, providing a route for fast separations, while maintaining column performance. The reduced inlet pressures have also allowed the possibility of exploring the use of peristaltic pumps to push the mobile phase through the chromatographic bed for simple and portable HPLC systems (Victory et al., “Low-Pressure Gradient Micro-Ion Chromatography With Ultra-Short Monolithic Anion Exchange Column,” Analyst, 129:700-701 (2004)). Monolithic columns have attracted considerable attention in capillary electrochromatography (CEC) (Hilder et al., “Development and Application of Polymeric Monolithic Stationary Phases for Capillary Electrochromatography” Journal of Chromatography A 1044:3-22 (2004); Li et al., “Sol-Gel Stationary Phases for Capillary Electrochromatography,” Journal of Chromatography A, 1044:23-52 (2004); “Monolithic Materials: Preparation, Properties and Application,” in Svec, eds., Journal of Chromatography Library, Vol. 67, Elsevier:Amsterdam (2004); Tanaka et al., “Monolithic Silica Columns for HPLC, Micro-HPLC, and CEC,” Journal of High Resolution Chromatography, 23:111-116 (2000)), and it can be argued that much of the development in monolithic columns has come as a result of investigations in CEC, searching for new column technology that avoided the problems associated with packed beds in CEC. The monolithic structure simplifies column technology by eliminating difficulties encountered with frit fabrication in packed capillary columns for CEC and capillary liquid chromatography (CLC) (Colón et al., “Packed Beds Columns,” in Deyl, eds. Capillary Electrochromatography, Chapter 4, pp. 111-164, Elsevier:New York (2001)).

The two most common support materials used for monolithic columns are based on organic polymers or silica (Svec et al., “Continuous Rods of Macroporous Polymers as High-Performance Liquid Chromatography Separation Media,” Analytical Chemistry, 64:820-822 (1992); Hjerten et al. “High-Performance Liquid Chromatography on Continuous Polymer Beds,” Journal of Chromatography, 473:273-275 (1989); Cortes et al., “Porous Ceramic Bed Supports for Fused Silica Packed Capillary Columns Used in Liquid Chromatography,” Journal of High Resolution Chromatography and Chromatography Communications, 10:446-448 (1987); Tanaka et al., “Monolithic LC Columns.” Analytical Chemistry, 73:420A-429A (2001); Eeltink et al., “Comparison of the Efficiency of Microparticulate and Monolithic Capillary Columns,” Journal of Separation Science, 27:1431-1440 (2004); Minakuchi et al., “Octadecylsilated Porous Silica Rods as Separation Media for Reversed-Phase Liquid Chromatography,” Analytical Chemistry, 68:3498-3501 (1996); Victory et al., “Low-Pressure Gradient Micro-Ion Chromatography With Ultra-Short Monolithic Anion Exchange Column,” Analyst, 129:700-701 (2004); Hilder et al., “Development and Application of Polymeric Monolithic Stationary Phases for Capillary Electrochromatography” Journal of Chromatography A 1044:3-22 (2004); Li et al., “Sol-Gel Stationary Phases for Capillary Electrochromatography,” Journal of Chromatography A, 1044:23-52 (2004); “Monolithic Materials: Preparation, Properties and Application,” in Svec, eds., Journal of Chromatography Library, Vol. 67, Elsevier:Amsterdam (2004); Tanaka et al., “Monolithic Silica Columns for HPLC, Micro-HPLC, and CEC,” Journal of High Resolution Chromatography, 23:111-116 (2000)). The monolithic columns based on silica support, however, are the most popular. Monolithic columns have been prepared in both small (50-100 μm) and large (1-4.6 mm) inner diameter columns.

A research area of great interest is the development of metal oxides particulates (e.g., zirconia, alumina, and titania) as support materials for chromatography, since in most cases they offer a more pronounced chemical and thermal stability than silica and organic polymers. Two excellent and recent reviews by Nawrocki et al. show the current state-of-the-art of stable metal oxides for HPLC (Nawrocki et al., “Part I. Chromatography Using Ultra-Stable Metal Oxide-Based Stationary Phases for HPLC,” Journal of Chromatography A, 1028:1-30 (2004); Nawrocki et al., “Part II. Chromatography Using Ultra-Stable Metal Oxide-Based Stationary Phases for HPLC,” Journal of Chromatography A, 1028:31-62 (2004)). Zirconia (ZrO₂) has been the most widely and systematically studied metal oxide for chromatographic applications and a variety of stationary phases using this support media are now commercially available (Nawrocki et al., “Part I. Chromatography Using Ultra-Stable Metal Oxide-Based Stationary Phases for HPLC,” Journal of Chromatography A, 1028:1-30 (2004); Nawrocki et al., “Part II. Chromatography Using Ultra-Stable Metal Oxide-Based Stationary Phases for HPLC,” Journal of Chromatography A, 1028:31-62 (2004); Dunlap et al., “Zirconia Stationary Phases for Extreme Separations,” Analytical Chemistry, 73:598A-607A (2001)). Recent work with supports containing titania is also emerging (Silva et al., “Stability Evaluations of an Octadecyl Bonded Phase Based upon Titanium-Grafted Silica,” LC-GC, 22:632-641 (2004); Kimura et al., “Microanalysis for MDR1 ATPase by High-Performance Liquid Chromatography With a Titanium Dioxide Column,” Analytical Biochemistry, 326:262-266 (2004); Sekiguchi et al., “Analysis of Sugar Phosphates in Plants by Ion Chromatography on a Titanium Dioxide Column With Pulsed Amperometric Detection,” Journal of Chromatography A, 1039:71-76 (2004)). Zirconia-based support materials, in particular, have two very distinct advantages over silica-based stationary phases. First, the zirconia is more stable towards extremes of pH, while silica-based stationary phases are not; and second, zirconia is also more thermally stable than silica-based phases. The benefits of these stabilities allow one to obtain separations at pH values that are not common with silica-based stationary phases. Furthermore, faster separations are possible by an increase in operating temperature.

The benefits of the monolithic format as a chromatographic column, as well as the use of metal oxide materials (mainly zirconia-based) have been established. It follows that a significant advancement in HPLC column technology would be the development of monolithic structures based on metal oxide supports. Despite the eminent use of metal oxides as monolithic columns; however, only few initial attempts towards the development of metal oxide monoliths have been reported. For example, Lee and coworkers have reported preparing a monolithic structure by packing a capillary column with zirconia particles and then “gluing” or entrapping them in a polybutadiene matrix (Tang et al., “In Situ Crosslinked Polybutadiene-Encapsulated Zirconia as a Monolithic Column for Fast Solvating Gas Chromatography,” Journal of Microcolumn Separations, 11:415-420 (1999)). A different approach to metal oxide monoliths is to initially fabricate a silica monolith and then coat the monolith with the metal oxide; this approach is just beginning to be explored. For example, Shi et al. have reported preparing silica-based monolithic columns in capillary columns and then coating the monolithic columns with membrane-like zirconia; the columns were tested for electrochromatography (Shi et al., “Preparation and Evaluation of Zirconia-Coated Silica Monolith Capillary Electrochromatography,” Talanta, 63:593-598 (2004)). Nakanishi and coworkers have used the same concept to prepare HPLC monolithic columns coated with titania to separate adenosine and adenosine phosphates (i.e., AMP, ADP, ATP) (Miyazaki et al., “Titania-Coated Monolithic Silica as Separation Medium for High Performance Liquid Chromatography of Phosphorus-Containing Compounds,” Journal of Separation Science, 28:39-44 (2005)). However, a monolithic chromatographic column based completely on metal oxide has not been reported.

The present invention is directed to overcoming these deficiencies in the art.

### SUMMARY OF THE INVENTION

The present invention relates to a method of preparing a continuous, porous metal oxide monolith in a container. The method involves providing a reaction mixture containing a metal salt or metal alkoxide compound, a solvent, and a porogenic reagent. Next, an epoxide is added to the reaction mixture under conditions effective to initiate condensation and polymerization of the reaction mixture. Then, a container is filled with the reaction mixture after epoxide addition under conditions effective to obtain a continuous, porous metal oxide monolith in the container.

Another aspect of the present invention relates to a column including a tubular container and a continuous, porous Group IV metal oxide monolith in contact with the inner walls of the tubular container, where the Group IV metal oxide monolith is free of any support or matrix material.

The present invention also relates to an article including a continuous, porous Group IV metal oxide monolith, where the Group IV metal oxide monolith is free of any support or matrix material.

The present invention discloses the synthesis of a continuous, porous metal oxide monolith. In particular, metal oxide monoliths have been synthesized in situ inside capillary columns, where the metal oxide monoliths showed globular-like structure and through pores. Capillary electrochromatography (CEC) and capillary liquid chromatography (CLC) were performed using the metal oxide monolithic column, where results from a separation of a simple sample mixture showed the potential of the novel metal oxide monolithic columns.

Previously, many of the synthetic approaches to fabricate metal oxide bulk materials have utilized sol-gel chemistry, focusing on the use of metal alkoxide precursors of the form M(OR)ₙ, where M is the metal, R is an alkyl group, and n=2-5 (Kundu et al., “Monolithic Zirconia Gels From Metal-Organic Solutions,” Journal of Material Science Letters, 5:293-295 (1986), which is hereby incorporated by reference in its entirety). These precursors tend to be air sensitive, where they undergo hydrolysis to form an alcohol and precipitate metal oxide particulates, which makes them difficult to handle in air in most cases. Furthermore, preparation of metal oxide monoliths inside a column can be limited by the rapid rate of the reactions that form the monolithic structure—hydrolysis and polycondensation leading to polymerization. The monolithic gel may form too quickly, preventing the easy handling of the reaction solution to be introduced into the “mold” that will eventually form the chromatographic monolithic structure. In fact, it has been suggested that one of the main reasons why the synthesis of metal oxide monolithic structures of Group IV elements has been elusive is due to the fast hydrolysis/polycondensation rates of the alkoxides of these metals (Gash et al., “New Sol-Gel Route to Transition and Main-Group Metal Oxide Aerogels Using Inorganic Salt Precursors,” Journal of Non-Crystalline Solids, 285:23-28 (2001), which is hereby incorporated by reference in its entirety).

While it is still possible to use the metal alkoxide compounds in the reaction mixture of the present invention, the present invention discloses that metal salts of the form MXₙ (where X=anionic ligand and n=2-6), which are more readily available, less expensive, and more air-stable than the alkoxides, can be used instead of the metal alkoxides. Metal salts have been investigated as potential precursors to synthesize bulk metal oxide materials (Gash et al., “New Sol-Gel Route to Transition and Main-Group Metal Oxide Aerogels Using Inorganic Salt Precursors,” Journal of Non-Crystalline Solids, 285:23-28 (2001). Using such a precursor, the present invention identifies reaction conditions leading to metal oxide monolithic structures—hafnia and zirconia, for example—according to the following schemes:

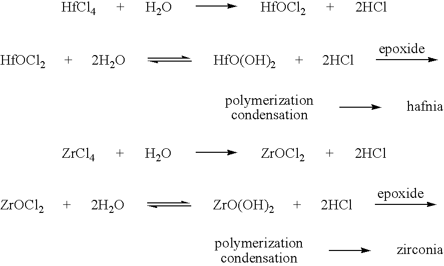

The addition of the epoxide drives the second reaction in each scheme towards the right, forming the metal oxide monolithic structures. Through condensation and polycondensation reactions, the material gels, forming a wet structure. To make it mechanically stronger, the material can be aged following gelation and then the solvent is removed.

Until the present application, there have been no reports of chromatographic monoliths based on a purely inorganic material, other than chromatographic monoliths based on silica. Zirconia is the most broadly and systematically studied metal oxide for chromatographic applications and a wide variety of stationary phases on particulate media have been implemented (Nawrocki et al., “Part I. Chromatography Using Ultra-Stable Metal Oxide-Based Stationary Phases for HPLC,” Journal of Chromatography A, 1028:1-30 (2004); Nawrocki et al., “Part II. Chromatography Using Ultra-Stable Metal Oxide-Based Stationary Phases for HPLC,” Journal of Chromatography A, 1028:31-62 (2004); Dunlap et al., “Zirconia Stationary Phases for Extreme Separations,” Analytical Chemistry, 73:598A-607A (2001), which are hereby incorporated by reference in their entirety). While zirconia has been studied as a chromatographic support material for separations, hafnia has not been investigated. In Group IV of the Periodic Table, hafnium is situated directly below zirconium. Despite the larger atomic mass and atomic number of hafnium, the properties of hafnium and zirconium and the reactivities and structures of their complexes are virtually identical, due to the Lanthanide contraction (Cotton et al., Advanced Inorganic Chemistry, Fifth Ed., John Wiley & Sons: New York, pp. 777 (1988), which is hereby incorporated by reference in its entirety). Nevertheless, the metal oxide of hafnium (i.e., hafnia) has not been studied as a chromatographic separation media. The monolithic columns and articles of the present invention, which are entirely based on metal oxides without any support or matrix materials commonly used for constructing monoliths (e.g., silica or organic polymers), possess the desirable qualities of monolithic columns with the added properties of better pH and thermal stabilities.

### BRIEF DESCRIPTION OF THE DRAWINGS

FIGS. 1A-C show scanning electron microscopy (SEM) images of a hafnia monolith inside a 50 μm i.d. column at two different magnifications (FIGS. 1A and 1B), and a SEM image of a zirconia monolithic pellet (FIG. 1C).

FIG. 2 shows SEM images of hafnia material prepared using different amounts of N-methylformamide in the reaction mixture, as indicated on each micrograph.

FIGS. 3A-B illustrate the separation of three components using capillary electrochromatography (CEC) (FIG. 3A) and capillary liquid chromatography (CLC) (FIG. 3B) using the hafnia monolithic column. Column: 29 cm, 50 mm capillary (21 cm effective length); mobile phase: 5 mM phosphate buffer pH=7.1; UV detection at 214 nm; hydrodynamic injection (15 s, 25 psi); in the CEC format, separation voltage of 25 kV; in the CLC format, 100 psi applied pressure; at 25° C. in both cases.

### DETAILED DESCRIPTION OF THE INVENTION

The present invention relates to a method of preparing a continuous, porous metal oxide monolith in a container. The method involves providing a reaction mixture containing a metal salt or metal alkoxide compound, a solvent, and a porogenic reagent. Next, an epoxide is added to the reaction mixture under conditions effective to initiate condensation and polymerization of the reaction mixture. Then, a container is filled with the reaction mixture after epoxide addition under conditions effective to obtain a continuous, porous metal oxide monolith in the container.

In one embodiment of the present invention, the reaction mixture before epoxide addition is allowed to age. Thus, the components in the reaction mixture before epoxide addition can be allowed to react for a sufficient period of time to develop and establish a monolith having a defined porous structure. Preferably, the reaction mixture before epoxide addition is aged for at least two days. Alternatively, the reaction mixture before epoxide addition can be heated to establish a monolith having a defined porous structure. Specifically, the reaction mixture before epoxide addition can be heated at a temperature of about 20° C. to about 100° C.

The container can be filled with the reaction mixture at any time before a significant amount of condensation and polymerization of the reaction mixture occurs. In one embodiment, the container is filled with the reaction mixture before the condensation and polymerization of the reaction mixture starts, i.e., right before or when the epoxide is added to the reaction mixture. Alternatively, the container can be filled with the reaction mixture during the condensation and polymerization of the reaction mixture, i.e., any time after the epoxide is added to the reaction mixture. The condensation and polymerization of the reaction mixture can be allowed to continue for a certain period of time. In one embodiment of the present invention, the condensation and polymerization of the reaction mixture are allowed to continue for at least 2 days. Alternatively, the reaction mixture after epoxide addition can be heated. Thus, in another embodiment of the present invention, the condensation and polymerization of the reaction mixture after epoxide addition can be carried out at a temperature of about 50° C.

In another embodiment of the present invention, the method can further involve heating the obtained continuous, porous metal oxide monolith, after the step of filling the container. Specifically, the metal oxide monolith can be initially heated at a temperature of about 20° C. to about 200° C. under conditions effective to remove the byproducts, solvents, and other unreacted materials from the monolith. Alternatively, the method can further involve washing the obtained continuous, porous metal oxide monolith with a solvent, after the step of filling the container, under conditions effective to remove the byproducts, solvents, and other unreacted materials from the monolith.

Further, after the byproducts, solvents, and other unreacted materials are removed from the metal oxide monolith, the monolith can be subsequently heated under conditions effective to form mesopores of the desired size (e.g., 2-100 nm in diameter). For example, the monolith can be heated at a temperature of about 200° C. to about 1,200° C. Alternatively, or in addition to this heating step, templating agents can be added to the initial reaction mixture (before epoxide addition) or to the reaction mixture (when or after the epoxide is being added) under conditions effective to form mesopores of the desired size. The use of these templating agents allows for a better tunability of the mesoporosity. Suitable templating agents include, but are not limited to, micelles (Yuan et al., “Surfactant-Assisted Synthesis of Unprecedented Hierarchical Meso-Macrostructured Zirconia,” Chemical Communications, 1558-1559 (2003); Blin et al., “Heirarchically Mesoporous/Macroporous Metal Oxides Templated From Polyethylene Oxide Surfactant Assemblies,”Angewandte Chemie International Edition, 42:2872-2875 (2003); Hirashima et al., “Preparation of Mesoporous Titania Gel Films and Their Characterization,” Journal of Non-Crystalline Solids, 350:266-270 (2004), which are hereby incorporated by reference in their entirety) and diblock copolymers (Weng et al., “Synthesis of Arrayed, TiO₂ Needlelike Nanostructures Via a Polystyrene-Block-Poly(4-vinylpyridine) Diblock Copolymer Template,” Chemistry of Materials, 16:4080-4086 (2004); Lazzari et al., “Block Copolymers as a Tool for Nanomaterial Fabrication,” Advanced Materials, 15:1583-1594 (2003); Förster et al., “Amphiphilic Block Copolymers in Structure-Controlled Nanomaterial Hybrids,” Advanced Materials, 10:195-217 (1998), which are hereby incorporated by reference in their entirety).

The metal oxide in the monolith of the present invention can be hafnia, zirconia, titania, alumina, niobia, yttria, magnesia, or mixtures thereof. Specifically, the metal oxide can be a Group IV metal oxide, such as hafnia, zirconia, and titania. More specifically, the Group IV metal oxide is hafnia or zirconia.

Suitable examples of metal salt compounds for the reaction mixture include, but are not limited to, HfCl₄, Hf(NO₃)₄, HfE₄, HfBr₄, HfI₄, ZrCl₄, Zr(NO₃)₄, ZrF₄, ZrBr₄, ZrI₄, TiCl₄, Ti(NO₃)₄, TiF₄, TiBr₄, TiI₄, AlCl₃, Al(NO₃)₃, AlF₃, AlBr₃, AlI₃, NbCl₅, Nb(NO₃)₅, NbF₅, NbBr₅, NbI₅, YCl₃, Y(NO₃)₃, YF₃, YBr₃, YI₃, MgCl₂, Mg(NO₃)₂, MgF₂, MgBr₂, and MgI₂ (Gash et al., “New Sol-Gel Route to Transition and Main-Group Metal Oxide Aerogels Using Inorganic Salt Precursors,” Journal of Non-Crystalline Solids, 285:23-28 (2001), which is hereby incorporated by reference in its entirety). Alternatively, metal salt oxide compounds (e.g., HfOCl₂, HfO(NO₃)₂, ZrOCl₂, ZrO(NO₃)₂, etc.)—both anhydrous forms or hydrates—can be used instead of the above metal salt compounds. In addition, metal alkoxide compounds can be used instead of the above metal salt compounds. Examples of metal alkoxides include normal and branched butoxides, propoxides, ethoxides, and methoxides of zirconium, hafnium, titanium, aluminum, silicon, niobium, etc., and mixtures thereof.

In another embodiment of the present invention, the solvent in the reaction mixture is water, an alcohol, such as methanol and ethanol (Gash et al., “New Sol-Gel Route to Transition and Main-Group Metal Oxide Aerogels Using Inorganic Salt Precursors,” Journal of Non-Crystalline Solids, 285:23-28 (2001), which is hereby incorporated by reference in its entirety), tetrahydrofuran, dimethylsulfoxide, N-methylformamide, ethylene glycol, or any other solvent that solubilizes the other components in the reaction mixture. Specifically, the solvent in the reaction mixture is water.

Suitable examples of the porogenic reagent in the reaction mixture include, but are not limited to, N-methylformamide, polyethylene glycol, polyethylene oxide, formamide, and dimethylformamide. Specifically, the porogenic reagent is N-methylformamide. The amount of the porogenic reagent in the reaction mixture of the present invention may vary, depending on the type of porogenic reagent. For N-methylformamide, for example, about 8 equivalents of N-methylformamide can be reacted with a solution of the metal salt or metal alkoxide compound.

Suitable examples of the epoxide include, but are not limited to, propylene oxide, trimethylene oxide, 3-methyl-3-oxetanemethanol, and dimethyloxetane (Gash et al., “Strong Akaganeite Aerogel Monoliths Using Epoxides: Synthesis and Characterization,” Chem. Mater. 15:3268-3275 (2003), which is hereby incorporated by reference in its entirety). Specifically, the epoxide is propylene oxide.

In another embodiment, the continuous, porous metal oxide monolith obtained by the method of the present invention has through pores that are about 0.5 μm to about 20 μm in diameter. In yet another embodiment, the continuous, porous metal oxide monolith obtained by the method of the present invention has mesopores that are about 2 nm to about 100 nm in diameter. More specifically, the mesopores can be about 2 nm to about 50 nm in diameter.

In one embodiment of the present invention, the container is a capillary having an inner diameter of about 0.001 mm to about 1 mm. The capillary is typically of a fused silica or a plastic material, but can be made of any other material.

In another embodiment of the present invention, the container is a column having an inner diameter larger than 1 mm. For example, in the case of preparative chromatography, columns with very large inner diameter up to a meter can be used. In another embodiment, the container is a column having an inner diameter of about 1 mm to about 6 mm. These columns are typically of a stainless steel or a plastic material, but can be made of any other material.

In addition to preparing the continuous, porous metal oxide monolith in columns (both small and large diameters), the method of the present invention can also further involve, after the step of filling, removing the container from the obtained monolith to prepare continuous, porous metal oxide monoliths in various shapes. The various shapes include, but are not limited to, bulk pellets, cylinders, rods (with a diameter larger than 1 mm, for example), channels (with dimensions in the order of about 1 to about 100 μm, for example), and any other shapes such as squares, rectangles, etc.

Thus, the present invention relates to a column, a porous filter, a porous disk, a porous rod, or any article containing a continuous, porous metal oxide monolith prepared by the above method.

Another aspect of the present invention relates to a column including a tubular container and a continuous, porous Group IV metal oxide monolith in contact with the inner walls of the tubular container, where the Group IV metal oxide monolith is free of any support or matrix material. In particular, the Group IV metal oxide in the monolith is not associated with any commonly used support or matrix material, such as silica or organic polymers.

The present invention also relates to an article including a continuous, porous Group IV metal oxide monolith, where the Group IV metal oxide monolith is free of any support or matrix material. The article can be an article of any shape including, but not limited to, a porous filter, a porous disk, and a porous rod-like structure.

The columns or articles of the present invention can be used for chromatographically separating molecules or single atom ions. For example, the columns or articles of the present invention can be used in capillary electrochromatography (CEC), capillary liquid chromatography (CLC), or high performance liquid chromatography (HPLC) (Hilder et al., “Development and Application of Polymeric Monolithic Stationary Phases for Capillary Electrochromatography” Journal of Chromatography A 1044:3-22 (2004); Li et al., “Sol-Gel Stationary Phases for Capillary Electrochromatography,” Journal of Chromatography A, 1044:23-52 (2004); “Monolithic Materials: Preparation, Properties and Application,” in Svec, eds., Journal of Chromatography Library, Vol. 67, Elsevier:Amsterdam (2004); Tanaka et al., “Monolithic Silica Columns for HPLC, Micro-HPLC, and CEC,” Journal of High Resolution Chromatography, 23:111-116 (2000), which are hereby incorporated by reference in their entirety). In addition, the columns or articles of the present invention can be used to conduct catalytic reactions (Parida et al., “Catalytic Ketonisation of Acetic Acid Over Modified Zirconia. 1. Effect of Alkali-Metal Cations As Promoter,” Journal of Molecular Catalysis A: Chemical, 139:73-80 (1999), which is hereby incorporated by reference in its entirety). For example, a reaction mixture can be flushed through the porous filter of the present invention or contacted with the column, porous disk, or porous rod of the present invention to conduct catalytic reactions.

In addition, the articles of the present invention, such as the porous filters, porous disks, and the porous rod-like structures, can be used for solid phase extraction (SPE) and solid phase microextraction (SPME), which are techniques used in sample preparation before analysis to remove impurities from a sample and/or to preconcentrate the sample (Alhooghani et al., “Sol-Gel Approach to in situ Creation of High pH-Resistant Surface-Bonded Organic-Inorganic Hybrid Zirconia Coating for Capillary Microextraction (In-Tube SPME),” Journal of Chromatography A 1062:1-14 (2005), which is hereby incorporated by reference in its entirety). The removal of impurities from the sample can be accomplished in two ways. First, the sample can be passed through the article of the present invention, which can be a porous membrane (filter), disk or rod-like structure. The impurities can be collected on the media to purify the sample that passes through. Alternatively, the impurities can pass through the sample while the target compounds are collected on the media. These compounds are then removed from the media by passing a small amount of solvent through it. Additionally, a porous, rod-like structure may be dipped into a solution where the target molecules become attached to the surface of the rod.

### EXAMPLES

The following examples are provided to illustrate embodiments of the present invention but are by no means intended to limit its scope.

### Example 1

### Materials and Instrumentation

Zirconium tetrachloride and hafnium tetrachloride were purchased from Strem Chemicals (Newburyport, Mass.). Pyridine, imidazole, pyrazole, n-methyl formamide and propylene oxide were obtained from Aldrich Chemical Company (Milwaukee, Wis.). Distilled water was purified using a Milli-Q UV Plus water purification system (Millipore; Bedford, Mass.). Fused silica capillary columns were obtained from Polymicro Technologies (Phoenix, Ariz.). Sodium dihydrogen phosphate was purchased from Fisher Scientific (Fair Lawn, N.J.).

The micrometer-range morphology of the monolithic material was observed by a S-4000 Field Emission Scanning Electron Microscope (Hitachi, Japan). Both liquid chromatography (LC) and CEC analyses were performed on a P/ACE MDQ capillary electrophoresis system (Beckman-Coulter; Fullerton, Calif.). Instrument control and data collection were performed with the P/ACE station software (v 1.0) supplied by Beckman-Coulter. Test analytes were monitored by UV at 214 nm. A phosphate buffer with pH=7.1 was used as the mobile phase. For both CEC and CLC, the sample was injected hydrodynamically (15 s, 25 psi) and the separation was carried out at 25° C., using 25 kV for CEC and 100 psi for CLC. The capillary had dimensions of 50 μm i.d. by 31.1 cm long (effective length of 22.5 cm).

### Example 2

### Column Preparation

Prior to the synthesis of the monolithic column, the fused silica capillary was rinsed with 1.0 M NaOH for 1 h and water for another hour. Then, it was flushed with 0.1 M HCl for 1 h, and water for 30 min. The drying step was performed using a nitrogen gas flow overnight at 120° C. To synthesize the metal oxide monoliths, an aqueous solution of metal chloride with eight equivalents of N-methylformamide were reacted. Propylene oxide (166 μL) was added to induce the polycondensation reactions leading to polymerization. The resultant solution was injected into a pretreated 50 μm i.d. fused silica capillary column. The capillary was sealed and kept in an oven at 50° C. for gelation. After aging, the capillary was washed using water.

### Example 3

### Testing of the Metal Oxide Monolithic Column

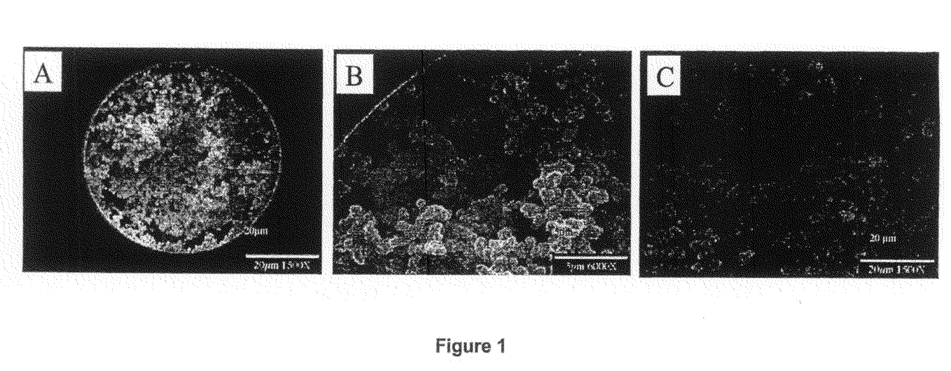

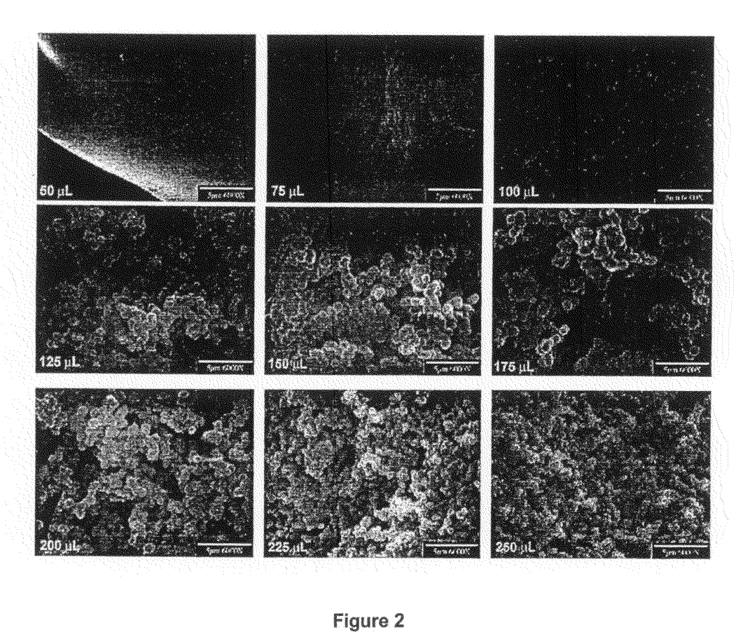

The metal oxide monoliths were synthesized in situ in both capillary columns and the bulk pellet format. FIGS. 1A-B show the scanning electron micrographs (SEM) of a hafnia monolith inside a capillary column, while FIG. 1C shows an SEM of a zirconia monolith in a pellet format. The figures show a globular interconnected microstructure and through pores of the metal oxide monoliths. N-methylformamide in the reaction mixture provided for through pore formation. FIG. 2 shows different SEM micrographs, illustrating the effects of different amounts of N-methylformamide in the reaction mixture. For the structures shown in FIGS. 1A-C, 150 μL of N-methylformamide was used. When the hafnia monolith was heated at 700° C., mesopores having diameters of about 15 nm were observed, while hafnia monoliths heated at 900° C. showed mesopores having diameters of about 35 nm.

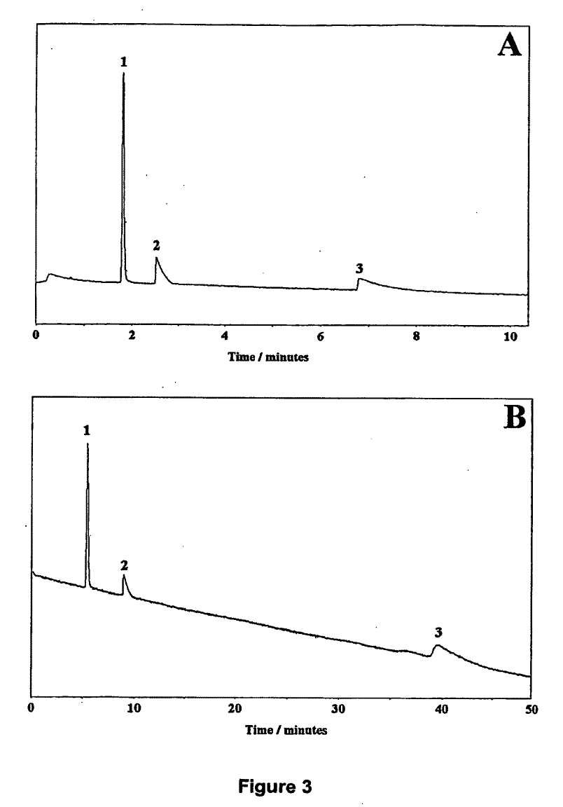

The suitability of the hafnia monolithic capillary column was tested under ligand-exchange chromatographic conditions, where three small molecules (i.e., pyridine, pryazole, and imidazole) were separated using CEC and CLC. Under the CEC conditions used, a relatively fast electroosmotic flow (EOF) was obtained and the three components were separated in less than eight minutes (see FIG. 3A). The components eluted according to their pKa values, indicating potential chromatographic interactions through the Lewis acid sites. Under the pressure driven mode of CLC, 100 psi was used to drive the mobile phase through the monolithic column, the upper limit being provided by the capillary electrophoresis (CE) unit used to perform the CEC experiment. This led to a longer analysis time (see FIG. 3B). The above results showed that the fabricated hafnia monolithic material was capable of separating the three components chromatographically.

Although the invention has been described in detail, for the purpose of illustration, it is understood that such detail is for that purpose and variations can be made therein by those skilled in the art without departing from the spirit and scope of the invention which is defined by the following claims.

What is claimed:

1. A method of preparing a continuous, porous metal oxide monolith in a container, said method comprising:
providing a reaction mixture comprising a metal salt or metal alkoxide compound, a solvent, and a porogenic reagent;
adding an epoxide to the reaction mixture under conditions effective to initiate condensation and polymerization of the reaction mixture; and
filling a container with the reaction mixture after epoxide addition under conditions effective to obtain a continuous, porous metal oxide monolith in the container.

2. The method according to claim 1, wherein the reaction mixture before epoxide addition is allowed to age.

3. The method according to claim 2, wherein the reaction mixture before epoxide addition is aged for at least two days.

4. The method according to claim 1, wherein the reaction mixture before epoxide addition is heated.

5. The method according to claim 4, wherein the reaction mixture before epoxide addition is heated at a temperature of about 20° C. to about 100° C.

6. The method according to claim 1, wherein said filling is carried out before said condensation and polymerization of the reaction mixture.

7. The method according to claim 1, wherein said filling is carried out during said condensation and polymerization of the reaction mixture.

8. The method according to claim 1, wherein said condensation and polymerization of the reaction mixture are allowed to continue for at least 2 days.

9. The method according to claim 1, wherein said condensation and polymerization of the reaction mixture are carried out at a temperature of about 50° C.

10. The method according to claim 1, further comprising:
adding a templating agent to the reaction mixture before or after epoxide addition under conditions effective to form mesopores of desired size.

11. The method according to claim 10, wherein the templating agent is a micelle or a diblock copolymer.

12. The method according to claim 1, further comprising:
heating the obtained continuous, porous metal oxide monolith after said filling.

13. The method according to claim 12, wherein the metal oxide monolith is initially heated at a temperature of about 20° C. to about 200° C. under conditions effective to remove byproducts, solvents, and other unreacted materials from the monolith.

14. The method according to claim 13, wherein the metal oxide monolith is subsequently heated at a temperature of about 200° C. to about 1,200° C. under conditions effective to form mesopores of desired size.

15. The method according to claim 1, further comprising:
washing the obtained continuous, porous metal oxide monolith with a solvent, after said filling, under conditions effective to remove byproducts, solvents, and other unreacted materials from the monolith.

16. The method according to claim 15, wherein the metal oxide monolith is subsequently heated at a temperature of about 200° C. to about 1,200° C. under conditions effective to form mesopores of desired size.

17. The method according to claim 1, wherein the metal oxide is selected from the group consisting of hafnia, zirconia, titania, alumina, niobia, yttria, magnesia, and mixtures thereof.

18. The method according to claim 17, wherein the metal oxide is a Group IV metal oxide selected from the group consisting of hafnia, zirconia, and titania.

19. The method according to claim 18, wherein the Group IV metal oxide is hafnia or zirconia.

20. The method according to claim 1, wherein the solvent is selected from the group consisting of water, alcohol, tetrahydrofuran, dimethylsulfoxide, N-methylformamide, and ethylene glycol.

21. The method according to claim 20, wherein the solvent is water.

22. The method according to claim 1, wherein the porogenic reagent is selected from the group consisting of N-methylformamide, polyethylene glycol, polyethylene oxide, formamide, and dimethylformamide.

23. The method according to claim 22, wherein the porogenic reagent is N-methylformamide.

24. The method according to claim 23, wherein said providing comprises combining a solution of the metal salt or metal alkoxide compound with about 8 equivalents of N-methylformamide.

25. The method according to claim 1, wherein the epoxide is selected from the group consisting of propylene oxide, trimethylene oxide, 3-methyl-3-oxetanemethanol, and dimethyloxetane.

26. The method according to claim 25, wherein the epoxide is propylene oxide.

27. The method according to claim 1, wherein the obtained continuous, porous metal oxide monolith has through pores that are about 0.5 μm to about 20 μm in diameter.

28. The method according to claim 1, wherein the obtained continuous, porous metal oxide monolith has mesopores that are about 2 nm to about 100 nm in diameter.

29. The method according to claim 1, wherein the container is a capillary having an inner diameter of about 0.001 mm to about 1 mm.

30. The method according to claim 29, wherein the capillary is of a fused silica or a plastic material.

31. The method according to claim 1, wherein the container is a column having an inner diameter larger than 1 mm.

32. The method according to claim 31, wherein the container is a column having an inner diameter of about 2 mm to about 6 mm.

33. The method according to claim 31, wherein the column is of a stainless steel or a plastic material.

34. The method according to claim 1 further comprising:
removing the container from the obtained continuous, porous metal oxide monolith after said filling.

35. A column, a porous filter, a porous disk, or a porous rod comprising a continuous, porous metal oxide monolith prepared by the method according to claim 1.

36. A column comprising
a tubular container; and
a continuous, porous Group IV metal oxide monolith in contact with the inner walls of the tubular container, wherein said Group IV metal oxide monolith is free of any support or matrix material.

37. The column according to claim 36, wherein the Group IV metal oxide is selected from the group consisting of hafnia, zirconia, titania, and mixtures thereof.

38. The column according to claim 37, wherein the Group IV metal oxide is hafnia or zirconia.

39. The column according to claim 36, wherein the continuous, porous Group IV metal oxide monolith has through pores that are about 0.5 μm to about 20 μm in diameter.

40. The column according to claim 36, wherein the continuous, porous Group IV metal oxide monolith has mesopores that are about 2 nm to about 100 nm in diameter.

41. The column according to claim 36, wherein the tubular container is a capillary having an inner diameter of about 0.001 mm to about 1 mm.

42. The column according to claim 41, wherein the capillary is of a fused silica or a plastic material.

43. The column according to claim 36, wherein the tubular container has an inner diameter larger than 1 mm.

44. The column according to claim 43, wherein the tubular container has an inner diameter of about 2 mm to about 6 mm.

45. The column according to claim 43, wherein the tubular container is of a stainless steel or a plastic material.

46. An article comprising a continuous, porous Group IV metal oxide monolith, wherein said Group IV metal oxide monolith is free of any support or matrix material.

47. The article according to claim 46, wherein the article is selected from the group consisting of a porous filter, a porous disk, and a porous rod.

48. The article according to claim 46, wherein the Group IV metal oxide is selected from the group consisting of hafnia, zirconia, titania, and mixtures thereof.

49. The article according to claim 48, wherein the Group IV metal oxide is hafnia or zirconia.

50. The article according to claim 46, wherein the continuous, porous Group IV metal oxide monolith has through pores that are about 0.5 μm to about 20 μm in diameter.

51. The article according to claim 46, wherein the continuous, porous Group IV metal oxide monolith has mesopores that are about 2 nm to about 100 nm in diameter.
